(19) United States
(12) Patent Application Publication
(10) Pub. No.: US 2025/0166982 A1
(43) Pub. Date: May 22, 2025

(54) MASS SPECTROMETRY AND NOISE ESTIMATION

(71) Applicant: DH Technologies Development Pte. Ltd., Singapore (SG)

(72) Inventor: Gordana Ivosev, Etobicoke, ON (CA)

(21) Appl. No.: 18/841,594

(22) PCT Filed: Feb. 24, 2023
(86) PCT No.: PCT/IB2023/051749

§ 371 Date: Aug. 26, 2024

Related U.S. Application Data
(60) Provisional application No. 63/314,535, filed on Feb. 28, 2022.

(51) Int. Cl. H01J 49/02; G06F 17/18

(52) U.S. Cl. CPC H01J 49/02; G06F 17/18

(57) ABSTRACT

Mass analysis systems, computing systems, non-transitory computer-readable media, and methods analyze peaks of interest in a mass spec data signal while accounting for acquisition parameters of a mass spectrometer that affect noise present in the mass spec data signal.

### RELATED APPLICATIONS

The present patent application claims the priority benefit of U.S. Provisional patent application Ser. No. 63/314,535, filed Feb. 28, 2022, the content of which is hereby incorporated by reference in its entirety into this disclosure.

### FIELD

The present disclosure relates generally to mass spectrometry, and more particularly, to noise estimates and analysis of signals generated by mass spectrometers.

### BACKGROUND

A common problem for qualitative and quantitative processing of mass spectrometry data is assessing whether a given peak of a signal is significant. A peak is generally considered significant if the peak exceeds background noise.

One approach for assessing a peak involves comparing the height of the peak to a region of the signal that appears to be free of peaks. Such a peak-free region may be representative of the background noise. If the height of the peak is large compared to the signal standard deviation level or baseline variance in the peak-free region, then there is a certain level of confidence that the peak is a real peak and not merely a noise spike.

However, this approach is less than ideal for several of reasons. For example:
The approach is subjective. The peak-free noise region is generally hand-selected and baseline variation may be hard to define from the selected region.
The signal may not include a peak-free region or peak-free regions may fail to provide enough sampling points for accurate statistical estimate of the noise.
The actual noise at the peak of interest may be different from the noise at the peak-free region.

As such, there may be benefits from techniques that better assess noise in a mass spectrometry signal and its effect on peaks of interest.

### SUMMARY

Various embodiments and aspects of mass analysis systems, computing systems, non-transitory computer-readable media, and methods for analyzing peaks of interest in a mass spec data signal are disclosed. In general, various embodiments account for acquisition parameters of a mass spectrometer that affect noise present in the mass spec data signal.

In various embodiments, a mass spectrometer generates a mass spec data signal for a sample. A computing system, coupled to the mass spectrometer, receives the mass spec data signal generated by the mass spectrometer and determines, for a data point of the mass spec data signal, a confidence interval for measured intensity based on a mathematical model derived from ion detection and measurement parameters of the mass spectrometer.

In some embodiments, the ion detection and measurement parameters may include an accumulation time of the mass spectrometer, and the mathematical model may be based on the accumulation time of the mass spectrometer. The ion detection and measurement parameters may also include a pulse frequency of the mass spectrometer, and the mathematical model may be based on the pulse frequency of the mass spectrometer. The ion detection and measurement parameters may include a detector response characteristic of the mass spectrometer, and the mathematical model may be based on the detector response characteristic of the mass spectrometer. The ion detection and measurement parameters may include an ion beam modulation parameter of the mass spectrometer, and the mathematical model may be based on the ion beam modulation parameter of the mass spectrometer.

In further aspects and embodiments of the present disclosure, the mass spectrometer comprises an ion detector used to generate the mass spec data signal based on one or more modulation factors, and the mathematical model may be based on a Poisson process and accounts for the one or more attenuation factors used to generate the mass spec data signal. In some embodiments, the modulation factor is an attenuation factor.

In various embodiments, the computing system generates a signal-to-noise ratio for the data point based on the confidence interval for a data point. The computing system may further detect peaks in the mass spec data signal based on the confidence interval for each data point. The computing system further presents a graphical representation of the mass spec data signal on a display device, and presents a noise envelope that depicts the confidence interval for the data point of the mass spec data signal.

In further embodiments, the computing system presents a graphical representation of the mass spec data signal on a display device, selects a peak of the mass spec data signal in response to input received via an input device, and presents the signal-to-noise ratio determined for the selected peak based on the confidence interval.

In yet further embodiments, the computing system filters out data points of the mass spec data signal based on their respective signal-to-noise ratios to obtain a filtered mass spec data signal, and presents a graphical representation of the filtered mass spec data signal on the display device.

In embodiments, a system is described, comprising: an analytical instrument configured to generate an analytical data signal for a sample that is representative of a measured intensity; and a computing system coupled to the analytical instrument, the computing system configured to: receive the analytical data signal generated by the analytical instrument; and determine, for a data point of the analytical data signal, a confidence interval for the measured intensity based on a mathematical model derived from one or more detection and/or measurement parameters of the analytical instrument.

The various aspects and embodiments of the present disclosure include systems, methods, devices, components, and/or software for implementing the various functions and processes described herein.

### DESCRIPTION OF DRAWINGS

Various aspects and embodiments of the present disclosure are shown in the drawings and described therein and elsewhere throughout the disclosure. In the drawings, like references indicate like parts.

FIG. 1 depicts a high-level block diagram of an example mass analysis system in accordance with various aspects and embodiments of the present disclosure.

FIG. 2 depicts further details of an example computing device of the computing system depicted in FIG. 1.

FIG. 3 depicts a flowchart of an example process for assessing significance of a peak in a mass spec data signal.

FIG. 4 depicts a mass spec data signal after normalization.

FIG. 5 depicts a smoothed version of a mass spec data signal after normalization.

FIG. 6 depicts an estimate of delta noise signal in the mass spec data signal.

FIG. 7 depicts an estimate of noise signal in the mass spec data signal which was reconstituted from the delta noise signal of FIG. 6.

FIG. 8 depicts a flowchart of another example process for assessing significance of a peak in a mass spec data signal.

FIG. 9 depicts another mass spec data signal after normalization.

FIG. 10 depicts a portion of the normalized mass spec data signal of FIG. 9 along with confidence level limits.

### DETAILED DESCRIPTION

In various aspects and embodiments of the present disclosure, systems, components, and devices, and combinations thereof, are provided for assessing noise in signals generated by a mass spectrometer.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry, for example, may operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module”, for example, may refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.”

As utilized herein, the term “exemplary” means serving as a non-limiting example, instance, or illustration. Further, as utilized herein, the terms “for example” and “e.g.,” set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example a semiconductor device may be turned sideways so that its “top” surface is facing horizontally and its “side” surface is facing vertically, without departing from the teachings of the present disclosure.

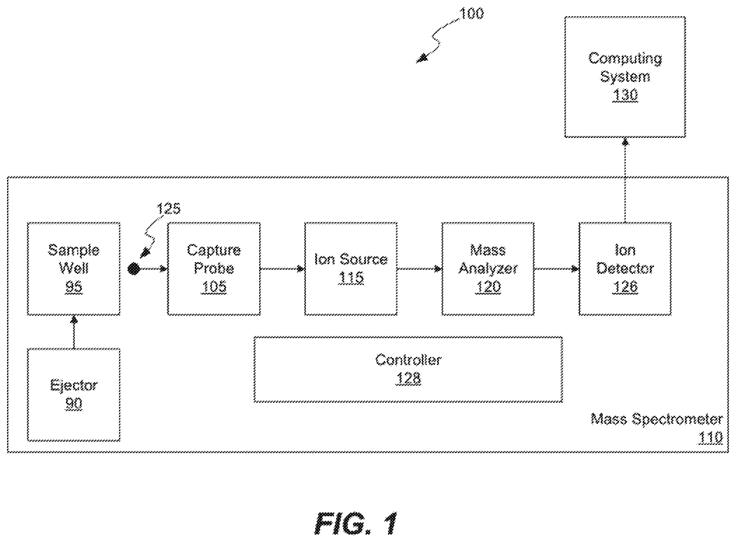

Referring now to FIG. 1, an example embodiment of a mass analysis system 100 is shown. As shown, the mass analysis system 100 may include a mass spectrometer 110 and a computing system 130 coupled to the mass spectrometer 110. The mass spectrometer 110 may separate and detect ions of interest from a given sample. The computing system 130 may be operative to control operation of the mass spectrometer 110, receive a mass spec data signal generated by the mass spectrometer, and manage the mass spec data signal received from the mass spectrometer 110. The computing system 130 may further analyze the mass spec data signal to produce one or more data reports, graphs, etc.

The mass spectrometer 110 may analyze ions generated from ionization of a sample. To this end, the mass spectrometer 110 may include an ejector 90, a sample well 95, a capture probe 105, an ion source 115, a mass analyzer 120, an ion detector 126, and a controller 128. The sample well 95 may receive a prepared sample to be analyzed. The ejector 90 may eject a sample 125 from the sample well. The capture probe 105 may capture the sample 125 and provide an ionized sample to other components of the mass spectrometer 110. In some embodiments, the ejector 90, the sample well 95, and the capture probe 105 may be part of an ejection system. Such an ejection system may be an external component that is distinct and separable from the other components of the mass spectrometer 110.

In general, the sample well 95 may locate its sample proximate to the capture probe 105 and the ejector 90 may selectively eject the sample into the capture probe 105. More specifically, the ejector 90 may eject samples 125 from the sample well 95. The ejector 90 may be any type of suitable ejector, such as an acoustic ejector or a pneumatic ejector. In an example embodiment, the sample well 95 is aligned with a capture opening of the capture probe 105. While aligned with the capture opening of the capture probe 105, the ejector 90 may eject a sample 125 from the sample well 95. The capture probe 105 may be operative to capture the sample 125 via its capture opening, optionally dilute the captured sample 125, and transport the sample 125 to the ion source 115 of the mass spectrometer 110.

The controller 128 may be operatively coupled to the ejector 90, capture probe 105, ion source 115, mass analyzer 120, and ion detector 126 in order to controller the respective components. In particular, the controller 128 may be configured to operate the ejector 90 so as to eject a sample 125 into the capture probe 105. The controller 128 may be, but is not limited to, a microcontroller, a computer, a microprocessor, or any device capable of sending and receiving control signals and data. Wired or wireless connections between the controller 128 and the remaining elements of the mass spectrometer 110 are not depicted but would be apparent to a person of skill in the art.

The capture probe 105 may dilute and transport a delivered sample to the ion source 115 disposed downstream of the capture probe 105. A mass analyzer 120 may receive the generated ions from the ion source 115 for mass analysis. The mass analyzer 120 may be operative to selectively separate ions of interest from generated ions received from the ion source 115 and to deliver the ions of interest to an ion detector 126 that generates a mass spectrometer signal indicative of detected ions to the computing system 130.

In some embodiments, the mass spectrometer 110 modulates detection by varying the ion transmission current (ITC) used to drive an ion beam of the mass spectrometer 110. For example, the mass spectrometer 110 may vary the ion transmission current (ITC) between 0.5% and 100%. Such variance may result in unequal count conversion factor for each cycle that was acquired with a different ITC attenuation factor. As further addressed below, detection of ions in such an embodiment is governed by a Poisson process whose parameters are varied by such modulation. Moreover, variance or modulation of ITC attenuation factors may affect relative noise (Rn) and accuracy of noise estimates in accordance with such varying (or modulated) Poisson process. Relative noise is explained in US Published Application US2009/0259438, incorporated by reference.

In other embodiments, the mass spectrometer 110 comprises an ion trap that generates a mass spec data signal based on modulation of ion intensity by one or more zeno-on-demand (ZOD) modulation factors across mass spec data signal. Detection of ions in such an embodiment is governed by a Poisson process, but underlying Poisson process parameters are modulated according to Zeno ON/OFF scheme and ZenoON mz function. More details on Zeno in general can be found in WO 2019/198010. Moreover, ZOD modulation factors may effect relative noise (Rn) and accuracy of noise estimates in accordance with such modulated Poisson process.

In some aspects, the separate ions of interest may be indicated in an analysis instruction associated with that sample. In some aspects, the separate ions of interest may be indicated in an analysis instruction identified by an indicia physically associated with the plurality of samples. For example, the mass analysis system 100 may further comprise the generation, assignment, and use of identifiers associated with collections of samples and/or individual samples. In such embodiments, the capture probe 105 and/or other components of mass spectrometer 110 may include readers that are capable of reading such identifiers associated with the collections of samples and/or the individual samples. For instance, an identifier associated with a sample well 95 may be read or scanned. In such aspects, the identifier(s) may be used by the mass spectrometer 110 and/or the mass analysis system 100 to associate mass spec data with samples 125. In some aspects, the identifier may comprise an indicia physically associated with the plurality of samples. In some aspects, the indicia may be readable by optical, electrical, magnetic, or other non-contact reading means. Indicia or identifiers in accordance with such aspects of the disclosure may include any characters, symbols, or other devices suitable for use in adequately identifying samples, sample collections, and/or handling or analysis instructions suitable for use in implementing the various aspects and embodiments of the present disclosure.

As shown, the mass spectrometer 110 may be coupled to the computing system 130. The computing system 130 may control operation of the mass spectrometer 110, receive a mass spec data signal from the mass spectrometer 110, analyze the mass spec data signal, and present results of such analysis of the mass spec data signal. To this end, the computing system 130 may include, for example, one or more SciexOS® and/or Analyst® computing devices available from Sciex LLC. The Analyst® and/or SciexOS® computing devices may include a control component for the capture probe 105, represented for example by Sciex open port probe (OPP) (also referred to as an open port interface (OPI)) software, and a control component for other components of the mass spectrometer 110 (e.g., ejector 90, ion source 115, mass analyzer 120, and/or ion detector 126).

The computing system 130 may comprise a single computing device or may comprise a plurality of computing devices in operative communication with the mass spectrometer 110 and/or one another. In certain embodiments, the computing system 130 may include cloud computing devices that provide services for analyzing mass spec data signals generated by a mass spectrometer.

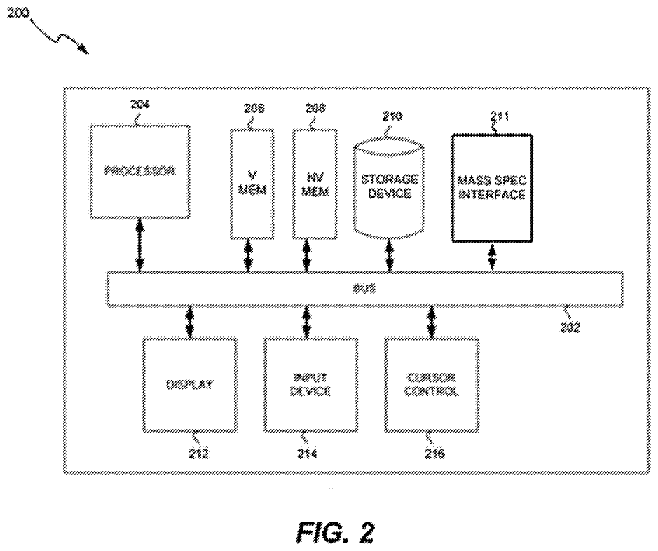

FIG. 2 illustrates a high-level block diagram of an example computing device 200 which may implement one or more computing devices of the computing system 130. To this end, the computing device 200 may comprise a bus 202, one or more processors 204, volatile memory 206, non-volatile memory 208, storage device 210, and a mass spectrometer interface 211. The bus 202 may comprise various signal lines, interfaces, etc. that operatively interconnect components of the computing device 200 such as the one or more processor 204, volatile memory 206, non-volatile memory 208, storage device 210, and mass spectrometer interface 211 to permit transfers of information and/or control signals between such components of the computing device 200.

The one or more processors 204 may each include a plurality of processing elements or cores, which may be packaged as a single processor or in a distributed arrangement. Furthermore, in some embodiments, the one or more processors 204 may provide a plurality of virtual processing elements that control and/or manage operations of the computing device 200.

The volatile memory 206 may include random access memory (RAM) and/or other dynamic storage devices coupled to bus 202. The volatile memory 206 may store instructions executed by the one or more processors 204. The volatile memory 206 may also store temporary variables, intermediate information, and/or other data resulting from execution of the instructions by the one or processors 204. The non-volatile memory 208 may include read-only-memory (ROM) devices, flash memory devices, and/or other non-volatile memory coupled to bus 202. The non-volatile memory 208 may store static information and instructions for the one or more processors 204. The storage device 210 may include one or more magnetic disk drives, optical disk drives, solid-state disk drives, and/or other mass storage devices coupled to bus 202. The storage device 210 may store information and/or instructions in a persistent manner for the one or more processors 204.

The one or more processors 204 may be coupled via bus 202 to the mass spectrometer interface 211. The mass spectrometer interface 211 may operatively couple the computing device 200 and the one or more processor 204 to the mass spectrometer 110 and its components. To this end, the mass spectrometer interface 211 may include various I/O and/or networking interfaces. For example, the mass spectrometer interface 211 may include I/O interfaces such as Universal Serial Bus (USB) interfaces, Peripheral Component Interconnect (PCI) interfaces, PCI Express interfaces, Serial Peripheral Interface (SPI) interfaces, FireWire interfaces, etc. Alternatively or additionally, the mass spectrometer interface 211 may include one or more networking interfaces such as Ethernet interfaces, Wi-Fi interfaces, and Bluetooth interfaces.

The one or more processors 204 may be further coupled via bus 202 to a display device 212, such as a light emitting diode (LED) or liquid crystal display (LCD). The one or more processors 204 may use the display device 212 to present information to a computer user. An input device 214, including alphanumeric and other keys, may be coupled to bus 202. A computer user may utilize the input device to communicate information and command selections to the one or more processors 204. The computing device 200 may further include a cursor control 216 coupled to the bus 202. The cursor control 216 may comprise as a mouse, a trackball, cursor direction keys, etc. which permit a computer user to select graphical elements or other aspects presented via the display device 212. In some embodiments, the cursor control 216 may control movement of a cursor on display device 212 used to select such graphical elements or other aspects presented via the display device 212. The cursor control 216 typically has two degrees of freedom in two axes, a first axis (e.g., a horizontal axis or x-axis) and a second axis (e.g., a vertical axis or y-axis), that permits the cursor control 216 to move a cursor across a plane of the display device 212 and select an x-y position in the plane.

Consistent with certain implementations of the present disclosure, the computing device 200 may operate based on the one or more processors 204 executing instructions stored in volatile memory 206. Such instructions may be read into volatile memory 206 from another computer-readable medium, such as storage device 210. Execution of the instructions stored in volatile memory 206 may cause the one or more processors 204 to perform various processes described herein. Alternatively, hard-wired circuitry may be used in place of or in combination with software instructions to implement various processes described herein. Thus, implementations of the present disclosure may utilize hardware circuitry and/or software to perform the various processes describe herein.

In various embodiments, the computing device 200 may be connected to one or more other computing devices across a network to form a networked system. Such other computing devices may be implemented in a manner similar to computing device 200. The network may comprise a private network or a public network such as the Internet. In the networked system, one or more computing devices may store and serve the data to other computing devices. The one or more computing devices 200 that store and serve the data may be referred to as servers, data servers, and/or a data cloud in a various cloud-computing scenarios. In some embodiment, the one or more computing devices 200 may include one or more web servers that provide other computing devices with web interfaces, web APIs, and/or other access to data and other resources of the one or more computing device. Such computing devices that send and receive data to and from the servers, data servers, and/or the data cloud regardless of whether via such web servers or web APIs may be referred to as client devices and/or cloud devices.

The term “computer-readable medium” as used herein refers to any media that participates in providing instructions to the one or more processor 204 for execution. Such a medium may take many forms including transitory media (e.g., transmission media) and non-transitory media (e.g., non-volatile media and volatile media). Transmission media may include, for example, coaxial cables, copper wire, fiber optics, the wires that comprise bus 202, and wireless transmissions. Non-volatile media may include, for example, non-volatile storage devices such as those of the non-volatile memory 208 and/or the storage device 210. Similarly, the volatile media may include, for example, volatile storage devices such as those of the volatile memory 206.

Common forms of non-transitory computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer may read.

Various forms of non-transitory computer-readable media may be involved in carrying one or more sequences of one or more instructions to the one or more processors 204 for execution. For example, the instructions may initially be carried on the magnetic disk of a remote computer. The remote computer may load the instructions into its dynamic memory and send the instructions over a communications link. A modem or other network interface local to the computing device 200 may receive the instructions transfer the received instructions to volatile memory 206 and/or the one or more processors 204 via bus 202. The instructions received by volatile memory 206 may optionally be stored to storage device 210 either before or after execution by the one or more processors 204.

Signal-to-noise (S/N) is a common metric used to assess whether a data point or peak of interest is a real peak. However, signal-to-noise (S/N) also relies on estimating the signal and the noise, which is very subjective and may be difficult to accurately define, especially if the background and/or noise signal changes or depends on the data point of interest in some way. For example, in a mass spectrometer that uses a pulse counting ion detector, the mass spec data signal is governed by Poisson statistics. Moreover, the variance of the mass spec data signal due to random noise is related to the square root of the mean of the measured intensity.

The computing system 130 per mass analysis process 300 may predict an expected noise range for a data point of the mass spec data signal by taking into account acquisition parameters of the mass spectrometer 110 and the magnitude of the mass spec data signal itself at the data point. The computing system 130 may then compare a data point or peak to the expected noise range to assess the significance of the data point or peak.

Furthermore, processing and/or acquisition techniques may influence the noise. For example, averaging a number of spectra generated from a sample reinforces the real signal but also reduces the random noise, thus providing a signal-to-noise (S/N) improvement. Thus the relative noise (Rn) may depend on more than just the measured signal provided by the mass spectrometer and may change. As such, the computing system 130 in various embodiments measures, calculates, and/or estimates the noise in order to obtain reliable and repeatable assessments of peaks.

There are many applications for noise estimates, one of which is calculation of signal-to-noise (S/N). As explained above, the mass spectrometer 110 may analyze a sample 125 and generate a mass spec data signal representative of the analyzed sample. The computing system 130 may receive such mass spec data signal from the mass spectrometer 110. In one embodiment, the mass spec data signal includes mass spec data that represents intensity of mass-to-charge (mz) measurements of ions in the sample 125 in counts-per-second (cps) as it is separated over time in a chromatograph. Moreover, the mass spec data signal may further include acquisition parameters associated with each of the mass-to-charge measurements or data points. For example, the acquisition parameters may include ITC attenuation factors used to generate the mass spec data signal.

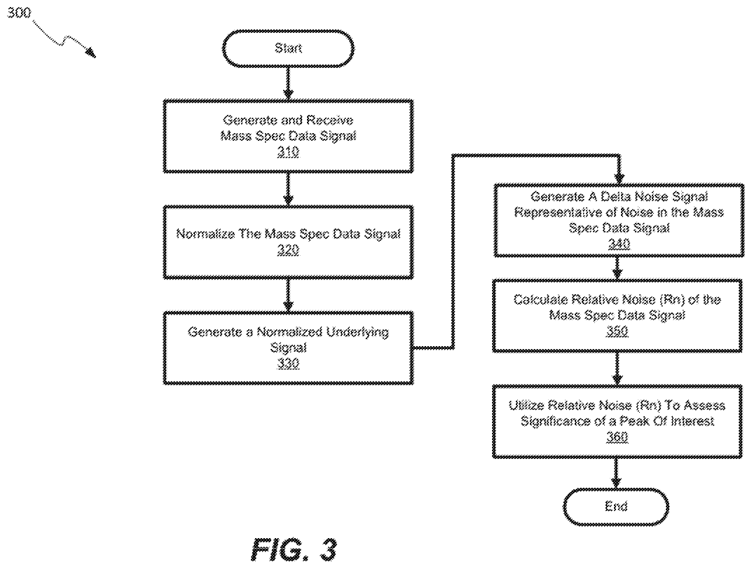

Referring now to FIG. 3, a flowchart depicts an embodiment of a mass analysis process 300 which may be implemented by the mass analysis system 100. In particular, the mass analysis process 300 may permit certain embodiments of the mass analysis system 100 to utilize acquisition parameters of the mass spectrometer 110 when determining the significance of a data point (e.g., a peak) and/or measure the signal-to-noise ratio (S/N) associated with such a data point.

The computing system 130 at 320 may normalize the mass spec data signal. For a mass spectrometer 110 comprising a pulse counting detector, the mass spec data signal is expected to follow a Poison process and the standard deviation of the measured signal is expected to be proportional to the square root of the measured signal. As such, the standard deviation of the mass spec data signal varies with the magnitude of the mass spec data signal assuming no variance in the ion transmission current (ITC). The mass spec data signal may also vary due to other noise components such as detection system response uncertainty and/or other components dependent on acquisition parameters of the mass spectrometer 110. Thus, the computing system 130 may devise an appropriate mathematical model of the noise and/or select a previously devised mathematical model and adjust its signal-to-noise analysis based on the selected mathematical model.

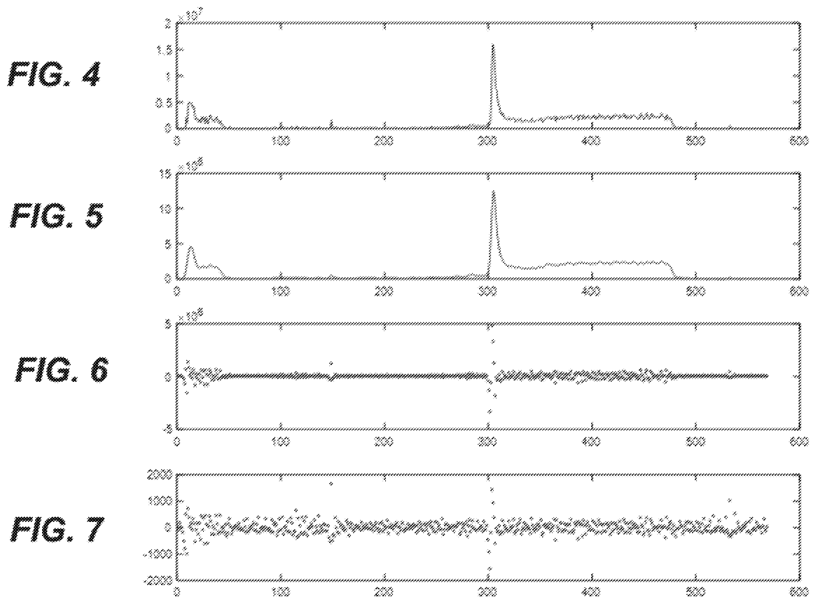

As noted above, the mass spectrometer 110 may vary the ion transmission current (ITC) between 0.5% and 100%. Such variance not only affects the conversion of detected counts to signal intensity values, but also augments the noise present in the mass spec data signal. To account for variance in the ion transmission current (ITC), the computing system 130 may normalize signals to detector count values, which have been adjusted to account for possible variances in accumulation times, ion transmission currents (ITC), and/or other acquisition parameters of the mass spectrometer 110. In other words, for each data point of the mass spec data signal, the computing system 130 at 320 may normalize each data point to account for the acquisition parameters associated with the data point. For example, the computing system 130 may convert each data point from a counts-per-second (cps) value to a counts value and may scale the converted data point based on an ITC attenuation factor for the respective data point. In particular, the computing system 130 may normalize each data point based on the following equation (1):

$$Counts ( i ) = MeasuredSignal ( i ) * CountConversionFactor ( i ) \qquad ( 1 )$$

where MeasuredSignal(i) corresponds to the i^{th} data point in the mass spec data signal received from the mass spectrometer 110; CountConversionFactor(i) provides a factor for converting the MeasuredSignal(i) to Counts(i); and Counts(i) corresponds to the number of counts for i^{th} data point after normalizing based on associated Accumulation Time(i) and ITCfactor(i). See, e.g., FIG. 4 which depicts a graph of the mass spec data signal received from the mass spectrometer 110 after normalization.

The CountConversionFactor(i) may account for mass spec acquisition parameters used by the mass spectrometer 110 to obtain the MeasuredSignal(i). For example, in some embodiments, the CountConversionFactor(i) may account for the accumulation time over which the detector accumulated ion counts to obtain i^{th} data point in the MeasuredSignal(i). Moreover, the CountConversionFactor(i) may account for the modulation factor. Modulation could be ion transmission current in effect (i.e., ITC factor) during the accumulation time over which ion counts were accumulated for the i^{th} data point. In one embodiment, the computing system 130 receives the associated accumulation times and ITC attenuation factors from the mass spectrometer 110 as part of and/or along with the mass spec data signal for a sample 125. Regardless the mass spectrometer 110 may provide the computing system 130 with the relevant acquisition parameters so as to permit the computing system 130 to perform conversion between counts and suitable intensity units.

At 330, the computing system 130 may generate an estimate of the underlying signal of the mass spec signal. In general, the computing system 130 generates a smoothed version of the normalized mass spec data signal, which is representative of an underlying signal of the mass spec data signal. To this end, the computing system 130 may normalize each data point of a smoothed version of the mass spec data signal based on the following equation (2):

$$SmoothCounts ( i ) = SmoothSignal ( i ) * CountConversionFactor ( i ) \qquad ( 2 )$$

where Smooth Signal(i) corresponds to the i^{th} data point in a smoothed version of the mass spec data signal received from the mass spectrometer 110; CountConversionFactor(i) provides a factor for converting the MeasuredSignal(i) to Counts(i); and SmoothCounts(i) corresponds to the number of counts for the data point after normalizing based on associated Accumulation Time(i) and ITCfactor(i). See, e.g., FIG. 5 which depicts a graph of a smoothed version of the mass spec data signal of FIG. 4.

The computing system 130 at 340 may generate a delta noise signal that is representative of the actual noise across the mass spec data signal. To this end, the computing system 130 may subtract the estimated underlying signal from the normalized mass spec data signal. In particular, the computing system 130 may subtract the underlying signal of FIG. 5 from the measured signal of FIG. 4 to obtain the delta noise signal of FIG. 6. More specifically, the computing system 130 may calculate the delta noise signal DeltaCounts(i) per below equation (3).

$$DeltaCounts ( i ) = ( SmoothCounts ( i ) - Counts ( i ) ) \qquad ( 3 )$$

FIG. 7 depicts a reconstituted noise signal. In particular, the reconstituted noise signal represents the delta noise signal of FIG. 6 converted from counts back to signal intensity levels. As shown in FIGS. 6 and 7, the range of the respective noise signal may be relatively constant, except for regions in which the mass spec data signal contained large peaks. Such variance in the delta noise signal is due to noise in the mass spec data signal being dependent on the magnitude of the mass spec data signal itself. Hence, the magnitude of the delta noise signal may be greater where the magnitude of the mass spec data signal is greater.

The computing system 130 at 350 may calculate the relative noise (Rn) of the mass spec data signal. The computing system 130 may calculate the relative noise (Rn) from the delta noise signal and the estimated underlying signal, which have both been normalized to account for the acquisition parameters as explained above at 330 and 340. In particular, the computing system 130 may calculate the relative noise Rn(i) for the i^{th} data point per below equation (4).

$$Rn ( i ) = \frac{DeltaCounts ( i )}{\sqrt{SmoothCouncs ( i )}} \qquad ( 4 )$$

The computing system 130 at 360 may then utilize the relative noise (Rn) to assess whether a peak or data point of interest is significant. For example, the computing system 130 may utilize the relative noise (Rn) to calculate estimated noise N(i) for an i^{th} data point per equations (5) and the signal-to-noise (S/N) for the i^{th} data point per equation (6).

$$N ( i ) = Rn ( i ) \sqrt{\frac{MeasuredSignal ( i ) * ITCFactor ( i )}{AccumulationTime ( i )}} \qquad ( 5 )$$

$$S / N ( i ) = \frac{MeasuredSignal ( i )}{N ( i )} \qquad ( 6 )$$

At 360, the computing system 130 may further graphically present the mass spec data signal and a signal-to-noise envelope that depicts the confidence interval for each data point on a display device 212. In some embodiments, the computing system 130 may permit a technician to select a peak of the graphically presented mass spec data signal. In such an embodiment, the computing system 130 may select the peak in response to input received via an input device such as cursor control 216, and may presents the signal-to-noise ratio determined for the selected peak on the display device 212. In yet further embodiments, the computing system 130 may filter out mass spec data based on their respective signal-to-noise ratios. In particular, the computing system 130 per an auto-peak detection process may exclude or filter out candidate peaks whose S/N ratios are below a predetermined or user-defined threshold value. In other embodiments, the computing system 130 may graphically present the mass spec data signal on display device 212 after filtering out data points whose S/N ratios are below a predetermined or user-defined threshold value.

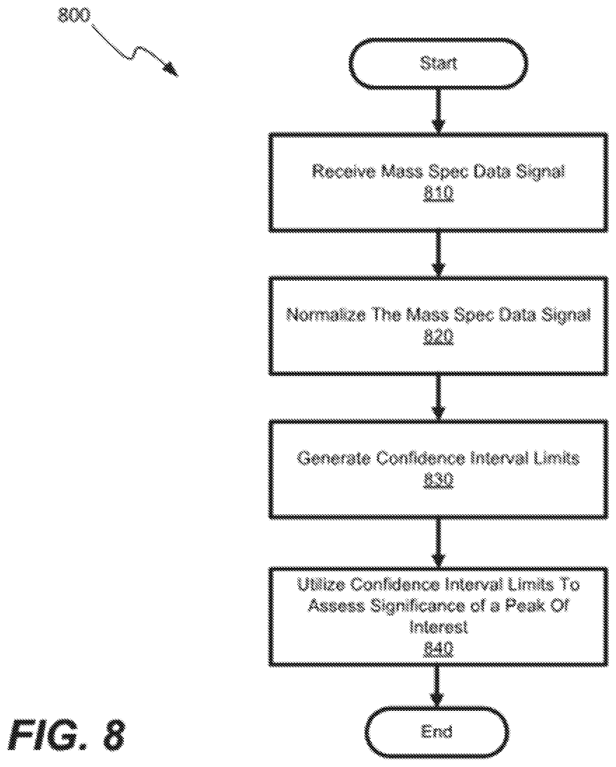

Referring now to FIG. 8, another process 800 for analyzing the significance of peaks is shown. In general, the computing system 130 per process 800 may predict the expected noise range for a data point in a mass spec data signal while taking into account acquisition parameters of the mass spectrometer 110 and the magnitude of the mass spec data signal itself at the data point. The computing system 130 may then compare a data point or peak to the expected noise range to assess the significance of the data point or peak.

To this end, the computing system 130 at 810 may receive a mass spec data signal from the mass spectrometer 110. In one embodiment, the mass spec data signal includes data that represents intensity of a mass-to-charge (mz) measurement for ions in the sample 125 in counts-per-second (cps). Moreover, the mass spec data signal may include acquisition parameters associated with each of the mass-to-charge measurements or data points. For example, the acquisition parameters may include ion transmission current (ITC) attenuation factors for each of the data points.

As noted above, the mass spectrometer 110 may vary the ion transmission current (ITC) between 0.5% and 100%. Such variance not only affects the conversion of detected counts to signal intensity values, but also varies the noise present in the mass spec data signal. To account for such variance induced by the ion transmission current (ITC), the computing system 130 may at 820 normalize the mass spec signal to detector count values, which have been adjusted to account for possible variances in accumulation times, ion transmission currents (ITC), and/or other acquisition parameters of the mass spectrometer 110. In other words, for each data point of the mass spec data signal, the computing system 130 may normalize each data point to account for the acquisition parameters associated with the data point. For example, the computing system 130 may convert each data point from counts-per-second (cps) value to a counts value and may scale the converted data point based on an ITC attenuation factor for the respective data point. In particular, the computing system 130 may normalize each data point based on the above equation (1).

The computing system 130 at 830 may estimate noise per Poisson confidence interval limits. In particular, the computing system 130 may determine an upper confidence limit UpperLimit(i) and a lower confidence limit LowerLimit(i) per equations (7) and (8).

$$UpperLimit ( i ) = \frac{{χ}^{2} ( ( 1 - \frac{α}{2} ) , Counts ( i ) + 1 )}{2 * ITCfactor ( i )} \qquad ( 7 )$$

$$LowerLimit ( i ) = \frac{{χ}^{2} ( \frac{α}{2} ) , Counts ( i ) )}{ITCfactor ( i )} \qquad ( 8 )$$

where χ² is the Chi-Square Critical value, α is the desired significance level (e.g., 0.05 for a 95% confidence interval), Counts(i) is the normalized count value for the i^{th} data point of the mass spec data signal per equation (1); and ITCfactor(i) is the ion transfer current associated with the i^{th} data point.

The computing system 130 at 840 may utilize the determined upper and lower limits for a desired confidence interval (e.g., 95%) to assess significance of a particular data point or peak. In particular, the computing system 130 may determine that the data point is a real peak if the peak height calculated by the difference between Counts(i) and a baseline is larger than a threshold, where threshold is proportional to the difference between the upper limit UpperLimit(i) and the lower limit LowerLimit(i) for the data point and can be calculated by:

threshold=constant*(UpperLimit−LowerLimit), where constant is >0.

If the peak height is lower than the threshold, the data point is not representative of a real peak. This threshold can be predetermined or based on historical values.

The computing system 130 may utilize such determined limits for the desired confidence interval in a number of different manners. One such example is determining whether a peak is a noise artifact. For example, the computing system 130 may present the upper and lower limits of the confidence interval on a display device 212 along with a graphical representation of the mass spec data signal. In this manner, the upper and lower limits may graphically present a signal envelop which the computing system 130 may utilize to assess whether a peak is a real peak or an artifact. In particular, if the peak lies within the envelope being contained within the upper and lower limits of the confidence interval, the computing system 130 may determine the peak to be a real peak and if the peak lies outside of the envelope, then the computing system 130 may determine the peak to be an artifact. Similarly, this determination can also be made without having to depict the signals in a graphical manner.

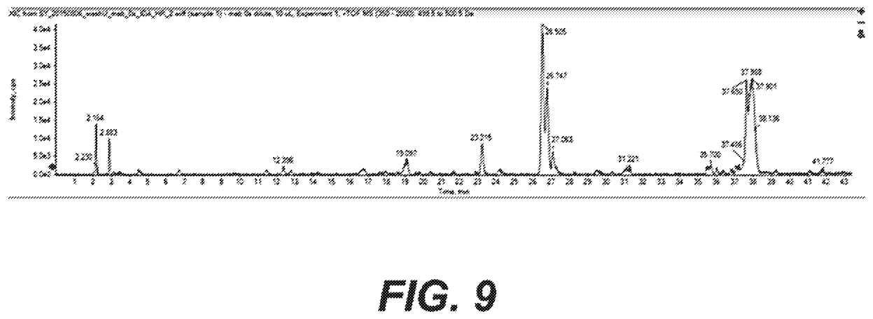

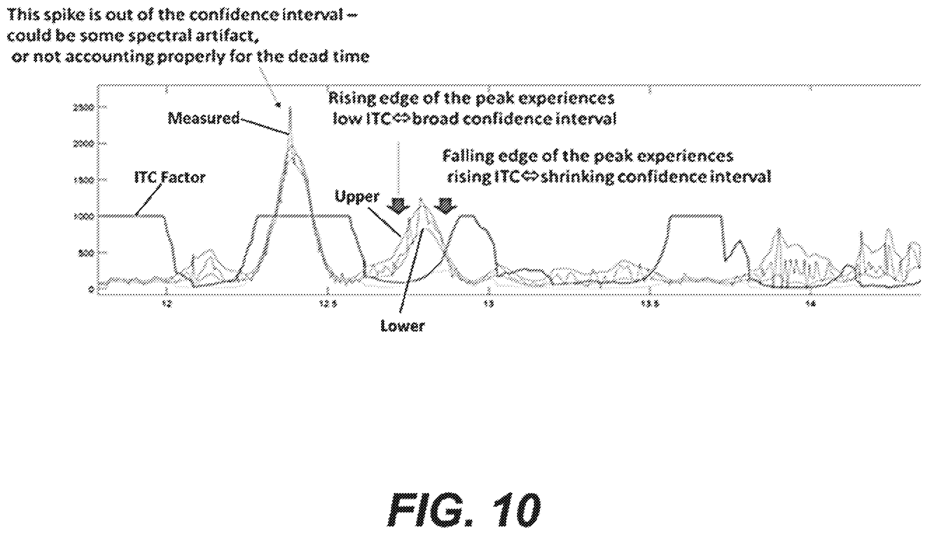

FIG. 9 shows a graph of a mass spec data signal generated by the mass spectrometer 110 and received by the computing system 130. FIG. 10 shows a zoomed-in portion of the mass spec data signal of FIG. 9 and the associated smoothed mass spec data signal. FIG. 10 further shows upper and lower limits of a confidence interval and the ITC attenuation factors associated with the measured and smoothed mass spec data signals. Of note, FIG. 10 identifies a peak that may be an artifact since it does not fall within the upper and lower limits of the confidence interval. FIG. 10 further shows that a rising edge of a peak may experience a lower ITC attenuation factor and a broad confidence interval. Conversely, a falling edge of a peak may experience a rising ITC attenuation factor and a shrinking confidence interval. In some embodiments, the computing system 130 may present a graphical representation of the mass spec data signal and confidence interval in a manner similar to FIG. 10.

In the above discussed example of FIGS. 4-10, noise was affected by a Poisson process or modulated Poisson process. In some embodiments, the mass spec data signal may be affected by additional sources of noise. In such embodiments, a noise model may be developed based on a convolution of one or more underlying noise sources. For example in some embodiments, detection system response uncertainty may affect the noise based on a binomial process and/or a Gaussian process, whose affects may be convolved with the Poisson process or modulated Poisson process. In other embodiments, analogue detection systems may introduce an additional noise component due to analogue response uncertainty for corresponding number of ions hitting the detector. This additional noise component may be described by a negative binomial distribution providing a mean and variance per equations (8) and (9):

$$mean = rp / ( 1 - p ) \qquad ( 8 )$$

$$variance = \frac{rp}{{( 1 - p )}^{2}} \qquad ( 9 )$$

where r is the number of successes and p is the probability of a success. r and p are detector model parameters for a corresponding ion rate. A determination as to whether a peak is significant may be based on the expected variance.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Generally, embodiments of the present disclosure may be implemented through the use of computer program products embodied on computer-readable medium. Such computer program products may include instructions executable by processors and/or computing devices such as processor 204 and/or computing system 130.

While specific embodiments directed as mass spectrometry have been specifically described herein, such concepts can also be applied to data other than mass spectrometry, in which similar acquisition parameters can be applied. For examples, detectors for radiation or optical light can also benefit from the teachings herein when modified by the person of ordinary skill in the art. While particular embodiments of the various aspects of the present disclosure have been illustrated and described, it would be apparent to those skilled in the art that various other changes and modifications can be made and are intended to fall within the spirit and scope of the present disclosure. Furthermore, although the present disclosure has been described herein in the context of particular implementations in particular environments for particular purposes, those of ordinary skill in the relevant arts will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system, comprising:
a mass spectrometer configured to generate a mass spec data signal for a sample; and
a computing system coupled to the mass spectrometer, the computing system configured to:
receive the mass spec data signal generated by the mass spectrometer; and
determine, for a data point of the mass spec data signal, a confidence interval for measured intensity based on a mathematical model derived from ion detection and measurement parameters of the mass spectrometer.

2. The system according to claim 1, wherein:
the ion detection and measurement parameters include an accumulation time of the mass spectrometer; and
the mathematical model is based on the accumulation time of the mass spectrometer.

3. The system according to claim 1, wherein:
the ion detection and measurement parameters include a pulse frequency of the mass spectrometer; and
the mathematical model is based on the pulse frequency of the mass spectrometer.

4. The system according to claim 1, wherein:
the ion detection and measurement parameters include a detector response characteristic of the mass spectrometer; and
the mathematical model is based on the detector response characteristic of the mass spectrometer.

5. The system according to claim 1, wherein:
the ion detection and measurement parameters include an ion beam modulation parameter of the mass spectrometer; and
the mathematical model is based on the ion beam modulation parameter of the mass spectrometer.

6. The system according to claim 1, wherein the mathematical model is based on a Poisson process.

7. The system according to claim 6, wherein:
the mass spectrometer comprises an ion detector used to generate the mass spec data signal based on one or more attenuation factors; and
the mathematical model accounts for the attenuation factors used to generate the mass spec data signal.

8. The system according to claim 1, wherein:
the mass spectrometer comprises an ion trap used to generate the mass spec data signal based on one or more attenuation factors; and
the mathematical model accounts for the one or more attenuation factors used to generate the mass spec data signal.

9. The system according to any of claims 1 through 8, wherein the computing system is configured to generate a signal-to-noise ratio for the data point based on the confidence interval for the data point.

10. The system according to claim 9, wherein the computing system is configured to detect peaks in the mass spec data signal based on the confidence interval for the data point.

11. The system according to claim 9, comprising:
a display device;
wherein the computing system is configured to:
present graphical representation of the mass spec data signal on the display device; and
present a signal-to-noise envelope that depicts a confidence interval for each data point of the mass spec data signal.

12. The system according to claim 9, comprising:
an input device; and
a display device;
wherein the computing system is configured to:
present a graphical representation of the mass spec data signal on the display device;
select a peak of the mass spec data in response to input received via the input device; and
present the signal-to-noise ratio determined for the selected peak based on the confidence interval.

13. The system according to claim 9, comprising
a display device; and
wherein the computing system is configured to:
filter out data points based on their respective signal-to-noise ratios to obtain a filtered mass spec data signal; and
present a graphical representation of the filtered mass spec data signal on the display device.

14. A computing system, comprising:
an interface configured to receive a mass spec data signal from a mass spectrometer; and
a processor configured to execute instructions stored in a memory, wherein execution of the instructions causes the processor to determine, for a data point of the mass spec data signal, a confidence interval for measured intensity based on a mathematical model derived from ion detection and measurement parameters of the mass spectrometer.

15. The computing system of claim 14, wherein:
the ion detection and measurement parameters include an accumulation time of the mass spectrometer; and
the mathematical model is based on the accumulation time of the mass spectrometer.

16. The computing system according to claim 14, wherein:
the ion detection and measurement parameters include a pulse frequency of the mass spectrometer; and
the mathematical model is based on the pulse frequency of the mass spectrometer.

17. The computing system according to claim 14, wherein:
the ion detection and measurement parameters include a detector response characteristic of the mass spectrometer; and
the mathematical model is based on the detector response characteristic of the mass spectrometer.

18. The computing system according to claim 14, wherein:
the ion detection and measurement parameters include an ion beam modulation parameter of the mass spectrometer; and
the mathematical model is based on the ion beam modulation parameter of the mass spectrometer.

19. The computing system according to claim 14, wherein the mathematical model is based on a Poisson process.

20. The computing system according to claim 19, wherein:
execution of the instructions cause the processor to receive one or more attenuation factors associated with an ion detector used to generate the mass spec data signal; and
the mathematical model accounts for the one or more attenuation factors used to generate the mass spec data signal.

21. The computing system according to claim 20, wherein:
execution of the instructions cause the processor to receive one or more attenuation factors for an ion trap used to generate the mass spec data signal; and
the mathematical model accounts for the one or more attenuation factors used to generate the mass spec data signal.

22. The computing system according to any of claims 14 through 21, wherein execution of the instructions causes the processor to generate a signal-to-noise ratio for the data point based on the confidence interval for the data point.

23. The computing system according to claim 22, wherein execution of the instructions causes the processor to detect peaks in the mass spec data signal based on the confidence interval for the data point.

24. The computing system according to claim 22, comprising:
a display device;
wherein execution of the instructions causes the processor to:
present a graphical representation of the mass spec data signal on the display device; and
present a signal-to-noise envelope that depicts the confidence interval for each data point of the mass spec data signal.

25. The computing system according to claim 22, comprising:
an input device; and
a display device;
wherein execution of the instructions causes the processor to:
present a graphical representation of the mass spec data signal on the display device;
select a peak of the mas spec data signal in response to input received via the input device; and
present the signal-to-noise ratio determined for the selected peak based on the confidence interval.

26. The computing system according to claim 22, comprising
a display device; and
wherein execution of the instructions causes the processor to:
filter out data points of the mass spec data signal based on their respective signal-to-noise ratios to obtain a filtered mass spec data signal; and
present a graphical representation of the filtered mass spec data signal on the display device.

27. A non-transitory computer-readable storage medium comprising instructions that, in response to being executed, cause a computing system to:
receive a mass spec data signal from a mass spectrometer; and
determine, for a data point of the mass spec data signal, a confidence interval for measured intensity based on a mathematical model derived from ion detection and measurement parameters of the mass spectrometer.

28. The non-transitory computer-readable storage medium according to claim 27, wherein:
the ion detection and measurement parameters include an accumulation time of the mass spectrometer; and
the mathematical model is based on the accumulation time of the mass spectrometer.

29. The non-transitory computer-readable storage medium according to claim 27, wherein:
the ion detection and measurement parameters include a pulse frequency of the mass spectrometer; and
the mathematical model is based on the pulse frequency of the mass spectrometer.

30. The non-transitory computer-readable storage medium according to claim 27, wherein:
the ion detection and measurement parameters include a detector response characteristic of the mass spectrometer; and
the mathematical model is based on the detector response characteristic of the mass spectrometer.

31. The non-transitory computer-readable storage medium according to claim 27, wherein:
the ion detection and measurement parameters include an ion beam modulation parameter of the mass spectrometer; and
the mathematical model is based on the ion beam modulation parameter of the mass spectrometer.

32. The non-transitory computer-readable storage medium according to claim 27, wherein the mathematical model is based on a Poisson process.

33. The non-transitory computer-readable storage medium according to claim 32, wherein the mathematical model accounts for one or more attenuation factors associated with an ion detector used to generate the mass spec data signal.

34. The non-transitory computer-readable storage medium according to claim 33, wherein the mathematical model accounts for one or more attenuation factors associated with an ion trap used to generate the mass spec data signal.

35. The non-transitory computer-readable storage medium according to any of claims 27 through 34, wherein the instructions, when executed, cause the computing system to generate a signal-to-noise ratio for the data point based on the confidence interval for the data point.

36. The non-transitory computer-readable storage medium according to claim 35, wherein the instructions, when executed, cause the computing system to detect peaks in the mass spec data signal based on the confidence interval for the data point.

37. The non-transitory computer-readable storage medium according to claim 35, wherein the instructions, when executed, cause the computing system to:
present a graphical representation of the mass spec data signal on a display device; and
present a signal-to-noise envelope that depicts the confidence interval for each data point of the mass spec data signal.

38. The non-transitory computer-readable storage medium according to claim 35, wherein the instructions, when executed, cause the computing system to:
present a graphical representation of the mass spec data signal on a display device;
select a peak of the mass spec data signal in response to input received via an input device; and
present the signal-to-noise ratio determined for the selected peak based on the confidence interval.

39. The non-transitory computer-readable storage medium according to claim 35, wherein the instructions, when executed, cause the computing system to:
filter out data points based on their respective signal-to-noise ratios to obtain a filtered mass spec data signal; and
present a graphical representation of the filtered mass spec data signal on a display device.

40. A system, comprising:
an analytical instrument configured to generate an analytical data signal for a sample that is representative of a measured intensity; and
a computing system coupled to the analytical instrument, the computing system configured to:
receive the analytical data signal generated by the analytical instrument; and
determine, for a data point of the analytical data signal, a confidence interval for the measured intensity based on a mathematical model derived from one or more detection and/or measurement parameters of the analytical instrument.
